(19) United States
(12) Patent Application Publication
(10) Pub. No.: US 2012/0032405 A1
(43) Pub. Date: Feb. 9, 2012

(54) SEALING STRUCTURE FOR CONTINUOUSLY VARIABLE TRANSMISSION

(75) Inventors: Yasuki NISHIZAWA, Hang Zhou (CN); Kei ITO, Chiryu-shi (JP); Nobuyuki EGUCHI, Koriyama-shi (JP); Katsuyoshi SAKUMA, Kitaibaraki-shi (JP)

(73) Assignees: NOK CORPORATION, Tokyo (JP); AISIN AW CO., LTD., Anjo-shi (JP)

(21) Appl. No.: 13/195,377

(22) Filed: Aug. 1, 2011

(30) Foreign Application Priority Data
Aug. 6, 2010 (JP) 2010-177178

(51) Int. Cl. F16J 15/16

(52) U.S. Cl. 277/505

(57) ABSTRACT

A sealing structure for a continuously variable transmission, which seals a clearance between a movable sheave and a cylinder. The continuously variable transmission may change a groove width of each pulley of the cylinder by moving a corresponding movable sheave though supply and discharge of a hydraulic pressure to and from the cylinder. The sealing structure includes an outer peripheral side seal member that is ring-shaped and disposed in a ring-shaped groove formed in one of the movable sheave and the cylinder; and an inner peripheral side seal member that is more elastic than the outer peripheral side seal member, ring-shaped, and disposed in a layered manner in the ring-shaped groove on an inner peripheral side with respect to the outer peripheral side seal member. A side of the outer peripheral side seal member where it contacts the inner peripheral side seal member is chamfered.

### INCORPORATION BY REFERENCE

The disclosure of Japanese Patent Application No. 2010-177178 filed on Aug. 6, 2010 including the specification, drawings and abstract is incorporated herein by reference in its entirety.

### BACKGROUND OF THE INVENTION

The present invention relates to a sealing structure for a continuously variable transmission that seals a clearance between a movable sheave and a cylinder of the continuously variable transmission including: two pulleys connected to an input shaft and an output shaft, respectively, with the pulleys each including the movable sheave and a fixed sheave that are disposed facing each other; a belt that bridges the pulleys; and the cylinder that forms a hydraulic pressure chamber on a rear side of the movable sheave, wherein the continuously variable transmission is capable of changing a groove width of each of the pulleys by moving the corresponding movable sheave though supply and discharge of a hydraulic pressure to and from the cylinder.

### DESCRIPTION OF THE RELATED ART

As a sealing structure for a continuously variable transmission of this type, related art proposes a belt-type continuously variable transmission in which a clearance between a movable sheave of a primary pulley and a housing portion is provided with a seal member structured to tightly seal the clearance (for example, see Japanese Patent Application Publication No. JP-A-2009-275718). In this continuously variable transmission, the housing portion is disposed on a rear side of the movable sheave to serve as a cylinder, and a clearance between the movable sheave and the housing portion is sealed. This forms a hydraulic pressure chamber for pressing the movable sheave from the rear side by a hydraulic pressure.

### SUMMARY OF THE INVENTION

In a belt-type continuously variable transmission, a belt is sandwiched in a pulley in a semi-circular range. Therefore, a bending force in accordance with the product of a force that opens the pulley by the belt and a radius of a portion at which the belt contacts the pulley is produced within a range of an angle that indicates the meshing of the belt. The bending force acts once every full rotation of the pulley, and deforms the movable sheave and the housing portion (cylinder) to periodically crush the seal member provided in the clearance between the movable sheave and the housing portion. This may cause wear of the seal member. As a countermeasure, in order to suppress deformation of the sheave and the housing portion, the rigidity of these components may be increased, but the size and weight of the transmission may increase as a consequence.

It is a main object of a sealing structure for a continuously variable transmission according to the present invention to improve sealing performance while suppressing wear of the seal member, without using an excessively rigid sheave and cylinder.

In order to achieve the foregoing main object, the sealing structure for a continuously variable transmission according to the present invention employs the following means.

A first aspect of the present invention provides a sealing structure for a continuously variable transmission that seals a clearance between a movable sheave and a cylinder of the continuously variable transmission including: two pulleys connected to an input shaft and an output shaft, respectively, with the pulleys each including the movable sheave and a fixed sheave that are disposed facing each other; a belt that bridges the pulleys; and the cylinder that forms a hydraulic pressure chamber on a rear side of the movable sheave, wherein the continuously variable transmission is capable of changing a groove width of each of the pulleys by moving the corresponding movable sheave though supply and discharge of a hydraulic pressure to and from the cylinder. The sealing structure includes: an outer peripheral side seal member that is ring-shaped and disposed in a ring-shaped groove formed in one of the movable sheave and the cylinder; and an inner peripheral side seal member that is more elastic than the outer peripheral side seal member, ring-shaped, and disposed in a layered manner in the ring-shaped groove on an inner peripheral side with respect to the outer peripheral side seal member. Further, a side of the outer peripheral side seal member where the outer peripheral side seal member contacts the inner peripheral side seal member is chamfered.

In the sealing structure for a continuously variable transmission according to the first aspect, the ring-shaped outer peripheral side seal member having a rectangular cross section and the ring-shaped inner peripheral side seal member that is more elastic than the outer peripheral side seal member are respectively disposed, in a layered manner, in the ring-shaped groove formed in one of the movable sheave and the cylinder that forms the hydraulic pressure chamber on the rear side of the movable sheave. In the sealing structure, the side of the outer peripheral side seal member where the outer peripheral side seal member contacts the inner peripheral side seal member is chamfered. This chamfering forms a space (relief space) between a side wall of the ring-shaped groove and the outer peripheral side seal member. Thus, even when the clearance between the sheave and the cylinder varies due to deformation of the sheave and the cylinder caused by meshing of the belt, and the inner peripheral side seal member is thus periodically deformed, the inner peripheral side seal member can move into the space, whereby the occurrence of drag wear of the inner peripheral side seal member can be suppressed. Consequently, sealing performance can be ensured without using an excessively rigid sheave and cylinder. Here, according to a second aspect of the present invention, the “outer peripheral side seal member” may be chamfered by plane chamfering.

In the thus configured sealing structure for a continuously variable transmission according to a third aspect of the present invention, the outer peripheral side seal member may be a rectangular cross-sectioned seal ring, and the inner peripheral side seal member may be a circular cross-sectioned O-ring.

Further, in the sealing structure for a continuously variable transmission according to a fourth aspect of the present invention, the movable sheave may be formed with a cylindrical portion that extends in an axial direction from an outer peripheral portion of the movable sheave, the cylinder may include an outer peripheral portion that extends in a radial direction to near an inner peripheral surface of the cylindrical portion of the movable sheave, and the seal member may be attached to a groove formed along an entire circumference of an outer peripheral edge of the cylinder. In this type of the continuously variable transmission, because deformation of the clearance between the movable sheave and the cylinder is relatively large, and thus an amplitude of the deformation of the seal member is also relatively large, the effect of the present invention is more pronounced.

### BRIEF DESCRIPTION OF THE DRAWINGS

FIG. 1 is a structural diagram that shows an overall configuration of a power transmission apparatus 20;

FIG. 2 is an explanatory diagram that shows a meshing angle of a belt 40 for a primary pulley 34;

FIG. 3 is an explanatory diagram that illustrates how the primary pulley 34 and a primary cylinder 38 deform in a CVT 30 according to an embodiment;

FIG. 4 is an explanatory diagram that illustrates how an O-ring 52 deforms when a seal ring 50 of the embodiment is used;

FIG. 5 is an explanatory diagram that illustrates how the O-ring 52 deforms when a seal ring 150 of a comparative example is used;

FIG. 6 is an explanatory diagram that illustrates how a primary pulley 134 and a primary cylinder 138 deform in a CVT of the comparative example;

FIG. 7 is an explanatory diagram that shows a relationship between a rotational angle of the primary pulley 34 and a margin for crushing the O-ring 52;

FIG. 8 is an explanatory diagram that illustrates a relationship between a speed ratio, engine torque, and an amplitude of the margin for crushing the O-ring 52 in the CVT 30 of the embodiment;

FIG. 9 is an explanatory diagram that illustrates the relationship between the speed ratio, the engine torque, and the amplitude of the margin for crushing the O-ring 52 in the CVT of the comparative example;

FIG. 10 is a cross-sectional view of a seal ring 50B of a modification example; and

FIG. 11 is a cross-sectional view of a seal ring 50C of another modification example.

### DETAILED DESCRIPTION OF THE EMBODIMENT

Next, an embodiment of the present invention will be described.

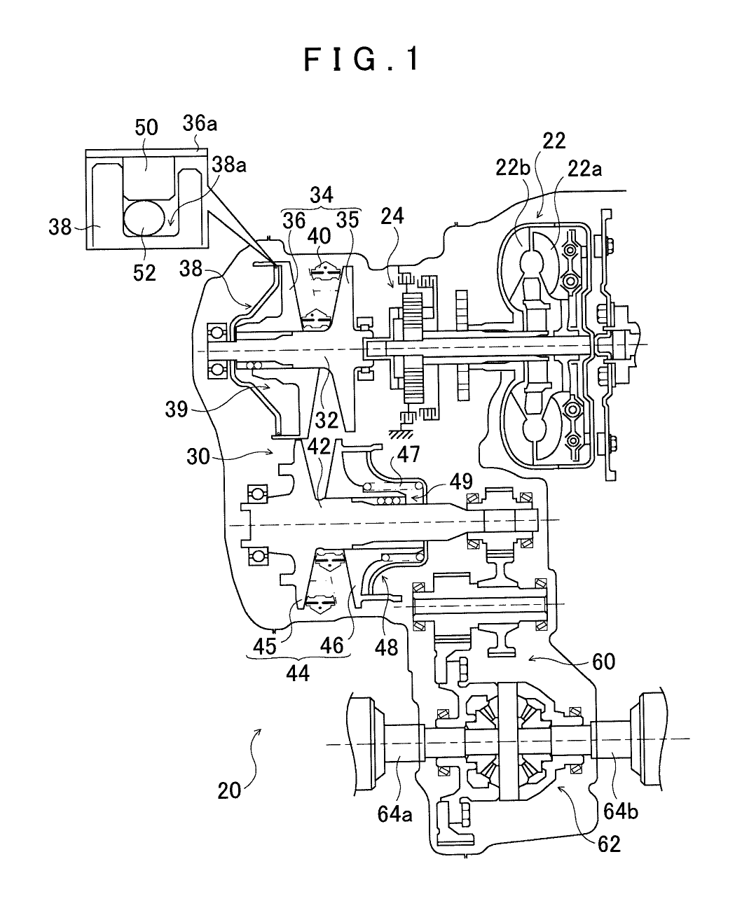

FIG. 1 is a structural diagram that shows an overall configuration of a power transmission apparatus 20. As shown in FIG. 1, the power transmission apparatus 20 is configured as a transaxle apparatus that transmits to axles 64a, 64b power from a transversely mounted engine (not shown) in which a crankshaft is disposed generally parallel to the axles 64a, 64b. The power transmission apparatus 20 includes a torque converter 22 with a lock-up clutch, a forward/reverse travel switching unit 24, and a continuously variable transmission (hereinafter abbreviated to “CVT”) 30. The torque converter 22 includes a pump impeller 22a on an input side connected to the crankshaft of the engine, and a turbine runner 22b on an output side. The forward/reverse travel switching unit 24 is connected to the turbine runner 22b of the torque converter 22 and outputs power input from the turbine runner 22b with such power converted into a positive rotation or a negative rotation. The CVT 30 includes a primary shaft 32 connected to the forward/reverse travel switching unit 24, and a secondary shaft 42 disposed parallel to the primary shaft 32. The CVT 30 steplessly changes a speed of power input to the primary shaft 32 and outputs power at the changed speed to the secondary shaft 42.

The CVT 30 includes a primary pulley 34, a secondary pulley 44, a belt 40, a primary cylinder 38, and a secondary cylinder 48. The primary pulley 34 is attached to the primary shaft 32, and the secondary pulley 44 is attached to the secondary shaft 42 disposed parallel to the primary shaft 32. The belt 40 is disposed in respective grooves of the primary pulley 34 and the secondary pulley 44 so as to bridge the primary pulley 34 and the secondary pulley 44. The primary cylinder 38 serves as a hydraulic actuator for changing a groove width in the primary pulley 34, and the secondary cylinder 48 serves as a hydraulic actuator for changing a groove width in the secondary pulley 44. The CVT 30 steplessly changes a speed of power input to the primary shaft 32 by changing the groove widths in the primary pulley 34 and the secondary pulley 44, and then outputs power at the changed speed to the secondary shaft 42. A hydraulic circuit, although not shown, supplies and discharges a hydraulic pressure to and from the primary cylinder 38 and to and from the secondary cylinder 48. The hydraulic circuit includes: an oil pump; a regulator valve that regulates a hydraulic pressure from the oil pump; a control valve that controls connection and disconnection of an oil passage for supplying and discharging the hydraulic pressure to and from the primary cylinder 38 and to and from the secondary cylinder 48, using the hydraulic pressure regulated by the regulator valve; and a solenoid valve that drives the control valve. The secondary shaft 42 is connected to the left and right axles 64a, 64b through a gear mechanism 60 and a differential gear 62, and therefore power from the engine is transmitted to the axles 64a, 64b, through the torque converter 22, the forward/reverse travel switching unit 24, the CVT 30, the gear mechanism 60, and the differential gear 62 in that order.

The primary pulley 34 is configured by a fixed sheave 35 that is formed integrally with the primary shaft 32, and a movable sheave 36 that is slidably supported by the primary shaft 32 in an axial direction through a ball spline. The secondary pulley 44 is configured by a fixed sheave 45 that is formed integrally with the secondary shaft 42, and a movable sheave 46 that is slidably supported by the secondary shaft 42 in the axial direction through a ball spline. It should be noted that the movable sheave 46 of the secondary pulley 44 is urged by a return spring 47 in a direction that reduces the groove width in the secondary pulley 44.

The movable sheave 36 of the primary pulley 34 is integrated with a piston and also formed with a cylindrical portion 36a that extends in the axial direction from an outer peripheral portion of the movable sheave 36 toward the primary cylinder 38 side. Further, the primary cylinder 38 includes an outer peripheral portion that extends in a radial direction to the vicinity of an inner peripheral surface of the cylindrical portion 36a of the movable sheave 36. A clearance between an outer peripheral edge of the primary cylinder 38 and the inner peripheral surface of the cylindrical portion 36a of the movable sheave 36 (piston) is sealed. This forms a hydraulic pressure chamber 39. In addition, the movable sheave 46 of the secondary pulley 44 is integrated with a piston and also formed with a cylindrical portion that extends in the axial direction from an outer peripheral portion of the movable sheave 46 toward the secondary cylinder 48 side. Further, the secondary cylinder 48 includes an outer peripheral portion that extends in the radial direction to the vicinity of an inner peripheral surface of the cylindrical portion of the movable sheave 46. A clearance between an outer peripheral edge of the secondary cylinder 48 and the inner peripheral surface of the cylindrical portion of the movable sheave 46 (piston) is sealed. This forms a hydraulic pressure chamber 49.

A ring groove 38a is formed along the entire circumference of the outer peripheral edge of the primary cylinder 38. A seal ring 50 and an O-ring 52 are attached on an outer peripheral side and an inner peripheral side of the ring groove 38a, respectively, in a layered manner. The seal ring 50 is made of a resin material (for example, fluorine resin) and has a rectangular cross section, and the O-ring 52 is made of a rubber material with higher elasticity than that of the seal ring 50 (for example, fluorine rubber) and has a circular cross section. Among four corners of the seal ring 50, two corners on a side where the seal ring 50 contacts the O-ring 52 are chamfered. In the embodiment, the two corners are chamfered by plane chamfering at a chamfering angle of generally 45 degrees. The reason for chamfering the seal ring 50 will be described later.

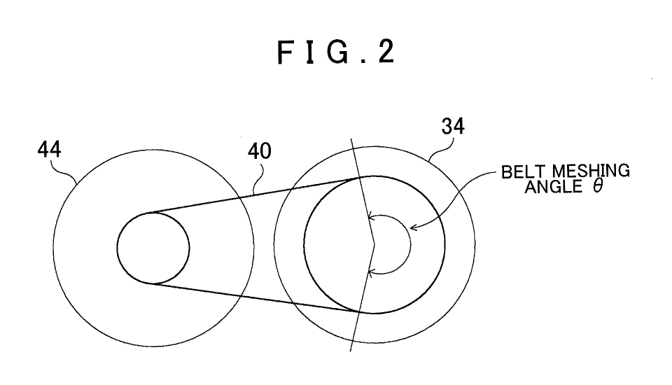

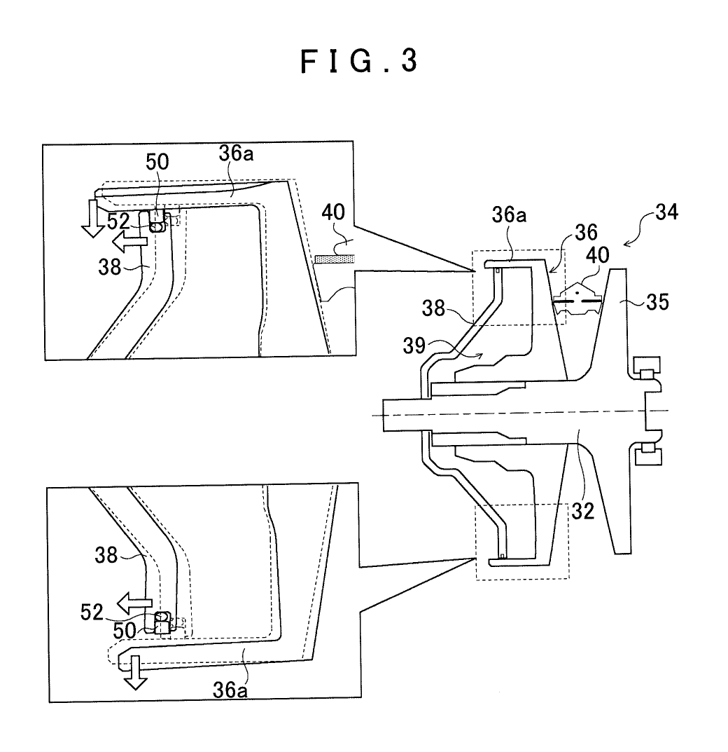

FIG. 2 is an explanatory diagram that shows how the belt 40 meshes in the primary pulley 34. As shown in FIG. 2, because the belt 40 is sandwiched in the primary pulley 34 in a semi-circular range, a bending force in accordance with the product of a force that opens the pulleys toward one side by the belt 40 and a radius of a portion at which the belt 40 contacts the primary pulley 34 acts on the primary pulley 34 within a range of a meshing angle θ that indicates the meshing of the belt 40. This bending force acts once every full rotation of the primary pulley 34. Therefore, the primary pulley 34 and the primary cylinder 38 periodically deform once every full rotation thereof. FIG. 3 shows how the primary pulley 34 and the primary cylinder 38 deform in the CVT 30 according to the embodiment. It should be noted that dotted lines in FIG. 3 indicate a state before deformation, and solid lines indicate the state after deformation. As illustrated, the primary pulley 34 (movable sheave 36) deforms in a direction that causes the cylindrical portion 36a to approach an axial center in a section where the belt 40 meshes, and deforms in a direction that causes the cylindrical portion 36a to separate from the axial center in a section where the belt 40 does not mesh. On the other hand, the primary cylinder 38 deforms in the axial direction opposite from the primary pulley 34 along the entire circumference. Such deformation of the primary pulley 34 and the primary cylinder 38 periodically changes a distance between a bottom surface of the ring groove 38a of the primary cylinder 38 and the inner peripheral surface (sliding surface) of the movable sheave 36 once every full rotation. Therefore, the O-ring 52 whose elasticity is higher than that of the seal ring 50 is crushed in the radial direction. In consideration of the hydraulic pressure generated in the hydraulic pressure chamber 39, the O-ring 52 is crushed in the radial direction in the state where the O-ring 52 and the seal ring 50 are together pressed in the axial direction against a side wall of the ring groove 38a of the primary cylinder 38 due to the hydraulic pressure in the hydraulic pressure chamber 39.

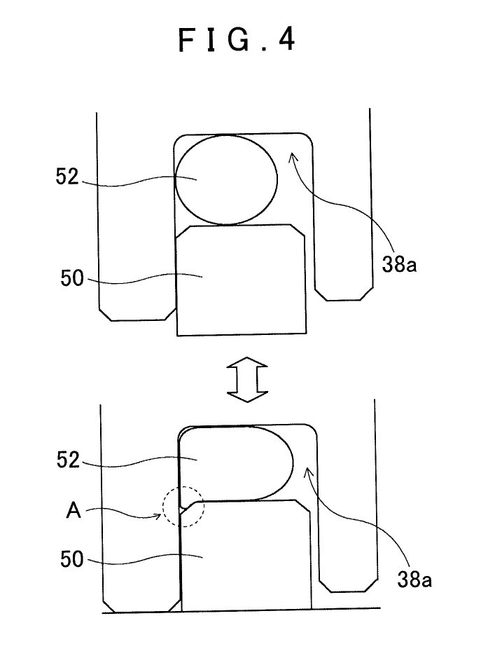

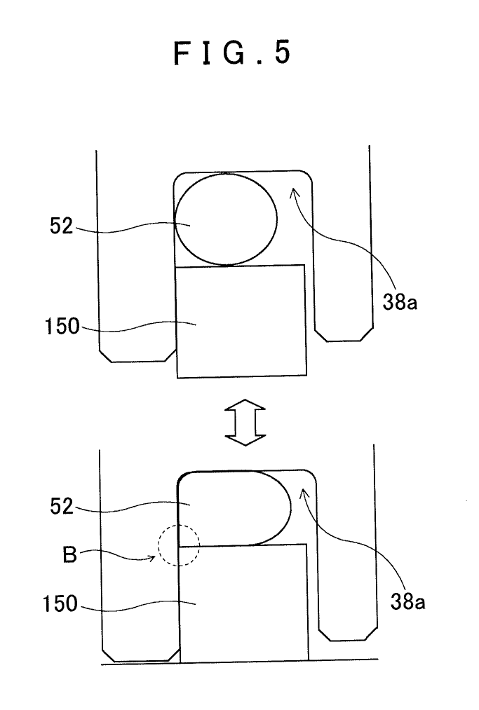

FIG. 4 shows how the O-ring 52 deforms when the seal ring 50 of the embodiment is used, and FIG. 5 shows how the O-ring 52 deforms when a seal ring 150 of a comparative example is used. Here, in FIG. 4, the seal ring 50 of the embodiment in which, among four corners in the rectangular cross section, two corners on the side where the seal ring 50 contacts the O-ring 52 are chamfered is used. Further, in FIG. 5, the seal ring 150 that has no chamfering is used. In the embodiment, as shown in FIG. 4, the two corners of the seal ring 50 on the side where the seal ring 50 contacts the O-ring 52 are chamfered. Therefore, a V-shaped groove is formed between the side wall of the ring groove 38a and a side surface of the seal ring 50 (see portion A in FIG. 4), and the O-ring 52 moves into the V-shaped groove when crushed. On the other hand, in the comparative example, the seal ring 150 is not chamfered. Accordingly, even when the O-ring 52 is crushed, there is no relief space into which the O-ring 52 can move (see portion B in FIG. 5), and drag wear occurs due to periodic crushing of the O-ring 52 occurring once every full rotation. Among four corners of the seal ring 50 in the rectangular cross section, two corners on the side where the seal ring 50 contacts the O-ring 52 are chamfered in order to suppress the occurrence of drag wear of the O-ring 52 by providing a relief space into which the O-ring 52 can move when the O-ring 52 is periodically crushed as the primary pulley 34 and the primary cylinder 38 deform.

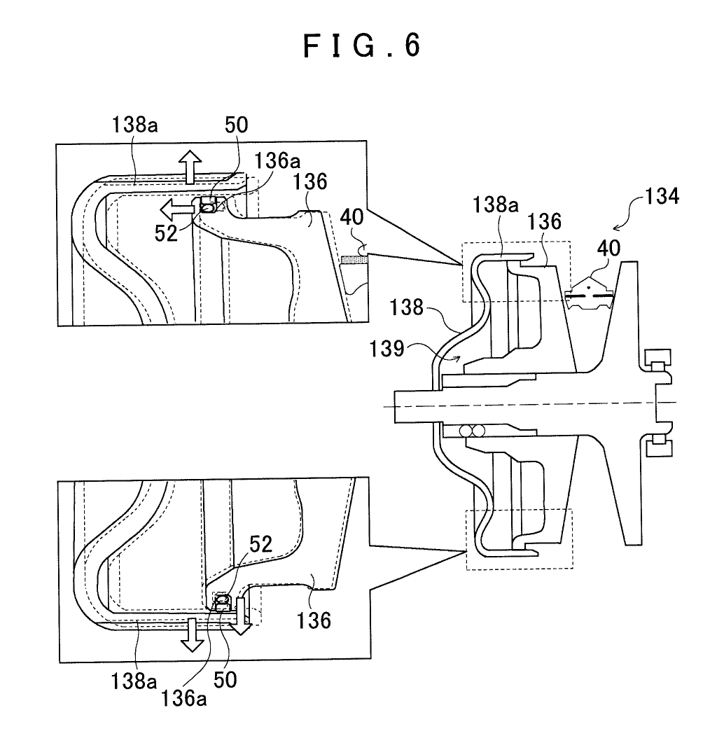

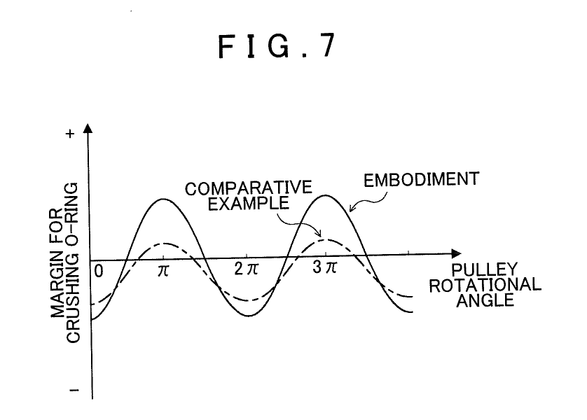

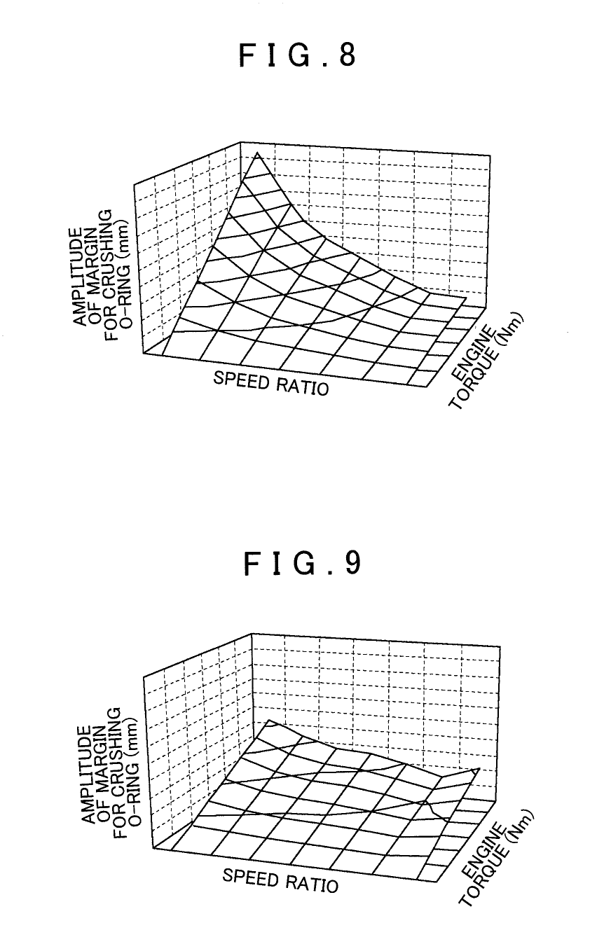

FIG. 6 is an explanatory diagram that illustrates how a primary pulley 134 and a primary cylinder 138 deform in a CVT of the comparative example. It should be noted that dotted lines in FIG. 6 indicate a state before deformation, and solid lines indicate a state after deformation. In this comparative example, as illustrated, the primary cylinder 138 is formed with a cylindrical outer peripheral portion 138a. A movable sheave 136 includes an outer peripheral portion that extends in the radial direction to the vicinity of an inner peripheral surface of the outer peripheral portion 138a of the primary cylinder 138. A ring groove 136a is formed along the entire circumference of an outer peripheral edge of the movable sheave 136, and the seal ring 50 and the O-ring 52 are attached to an outer peripheral side and an inner peripheral side of the ring groove 136a, respectively, in a layered manner. This forms a hydraulic pressure chamber 139. In the CVT of the comparative example thus configured, the primary pulley 134 (movable sheave 136) deforms in the axial direction toward the primary cylinder 138 side in a section where the belt 40 meshes in the primary cylinder 138, and deforms in a direction that causes the outer peripheral portion to separate from the axial center in a section where the belt 40 does not mesh in the primary cylinder 138. Further, the primary cylinder 138 deforms in the direction that causes the cylindrical portion 138a to separate from the axial center along the entire circumference. FIG. 7 shows a relationship between a rotational angle of the primary pulley 34 and a margin for crushing the O-ring 52. FIG. 8 shows a relationship between a speed ratio, an engine torque, and an amplitude of the margin for crushing the O-ring 52 in the CVT 30 of the embodiment. FIG. 9 shows the relationship between the speed ratio, the engine torque, and the amplitude of the margin for crushing the O-ring 52 in the continuously variable transmission of the comparative example. It should be noted that a solid line in FIG. 7 indicates the margin for crushing the O-ring 52 in the embodiment, and a chain line indicates the margin for crushing the O-ring 52 in the comparative example. As shown in FIGS. 7 to 9, the amplitude of the margin for crushing the O-ring 52 due to the deformation of the primary pulley 34 and the primary cylinder 38 tends to be larger in the embodiment compared to the comparative example. That is, in the embodiment, drag wear of the O-ring 52 is more likely to occur compared to the comparative example, and thus it is more meaningful to apply the present invention.

According to the sealing structure for a continuously variable transmission of the embodiment described above, the clearance between the movable sheave 36 and the primary cylinder 38 that forms the hydraulic pressure chamber 39 on the rear side of the movable sheave 36 is sealed by attaching the rectangular cross-sectioned seal ring 50 and the circular cross-sectioned O-ring 52 on the outer peripheral side and the inner peripheral side, respectively, in a layered manner, and two corners of the seal ring 50 on the side where the seal ring 50 contacts the O-ring 52 among the four corners are chamfered. This chamfering forms the V-shaped groove between the side wall of the ring groove 38a and the side surface of the seal ring 50, and the O-ring 52 can move into the V-shaped groove even when the O-ring 52 is periodically crushed due to deformation of the primary pulley 34 (the movable sheave 36) and the primary cylinder 38 caused by the belt 40, whereby the occurrence of drag wear of the O-ring 52 can be suppressed. Consequently, sealing performance can be ensured without using an excessively rigid movable sheave 36 and primary cylinder 38.

In the sealing structure for a continuously variable transmission according to the embodiment, the cylindrical portion 36a that extends in the axial direction from the outer peripheral portion of the movable sheave 36 is formed, and the outer peripheral portion of the primary cylinder 38 extends in the radial direction to the vicinity of the cylinder portion 36a. In addition, the ring groove 38a is formed along the entire circumference of the outer peripheral edge of the primary cylinder 38, and the seal ring 50 and the O-ring 52 are attached to the outer peripheral side and the inner peripheral side of the ring groove 38a, respectively, in a layered manner. This forms the hydraulic pressure chamber 39. However, as shown in FIG. 6, the hydraulic pressure chamber 139 may be formed by: cylindrically forming the outer peripheral portion 138a of the primary cylinder 138, extending the outer peripheral portion of the movable sheave 136 in the radial direction to the vicinity of the inner peripheral surface of the outer peripheral portion 138a of the primary cylinder 138, forming the ring groove 136a along the entire circumference of the outer peripheral edge of the movable sheave 136, and attaching the seal ring 50 and the O-ring 52 to the outer peripheral side and the inner peripheral side of the ring groove 136a, respectively, in a layered manner. In this case, as described above, the amplitude of the margin for crushing the O-ring 52 in accordance with the rotation of the pulley 134 is smaller than that in the embodiment. It is thus slightly less meaningful, compared to the embodiment, to apply the present invention.

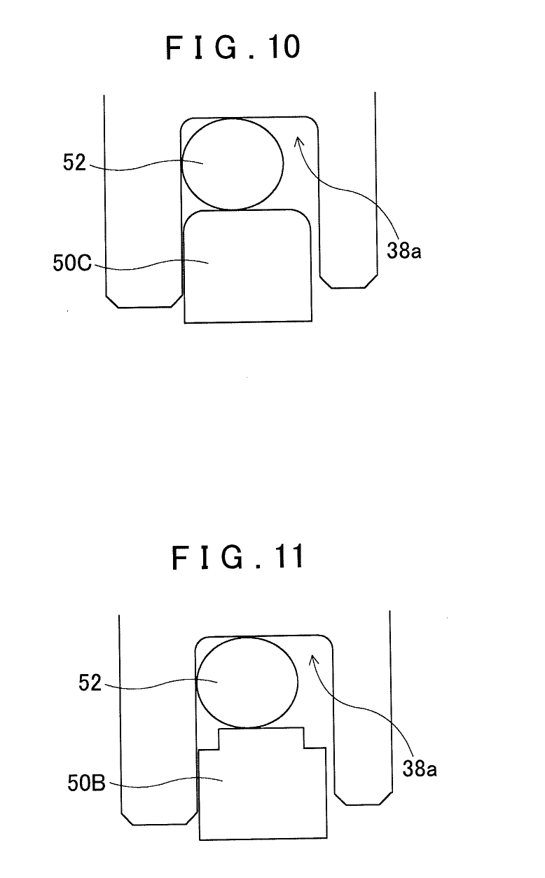

In the sealing structure for a continuously variable transmission according to the embodiment, the rectangular cross-sectioned seal ring 50 is chamfered by plane chamfering at a chamfering angle of generally 45 degrees. However, as long as a clearance (relief space) is formed between the side wall of the ring groove 38a of the primary cylinder 38 and the side surface of the seal ring 50 into which the O-ring 52 can move when the O-ring 52 is crushed due to a change in the clearance between the primary pulley 34 (movable sheave 36) and the primary cylinder 38, the chamfering angle for plane chamfering is not limited to 45 degrees, and may be other chamfering angles, such as 30 degrees, 40 degrees, 50 degrees, or 60 degrees. Moreover, the chamfering shape is not limited to plane chamfering, and may be any chamfering shapes, such as round chamfering (R chamfering) as shown by a seal ring 50B of a modification example in FIG. 10, and L-shaped chamfering as shown by a seal ring 50C of another modification example in FIG. 11.

In the sealing structure for a continuously variable transmission according to the embodiment, among four corners of the rectangular cross-sectioned seal ring 50, two corners on the side where the seal ring 50 contacts the O-ring 52 are chamfered. However, the present invention is not limited to this, and only one corner of two corners may be chamfered on the side where the seal ring 50 contacts the O-ring 52, which is located on a side opposite to the hydraulic pressure chamber 39 (a side where the seal ring 50 and the O-ring 52 are pressed against the side wall of the ring groove 38a of the primary cylinder 38 by the hydraulic pressure of the hydraulic pressure chamber 39).

Here, the correspondence relation will be explained between main elements of the embodiment and main elements of the invention as described in the Summary of the Invention. In the embodiment, the seal ring 50 corresponds to an “outer peripheral side seal member”, and the O-ring 52 corresponds to an “inner peripheral side seal member”. Note that with regard to the correspondence relation between the main elements of the embodiment and the main elements of the invention as described in the Summary of the Invention, the embodiment is only an example for giving a specific description of the invention explained in the Summary of the Invention. This correspondence relation does not limit the elements of the invention as described in the Summary of the Invention. In other words, any interpretation of the invention described in the Summary of the Invention shall be based on the description therein; the embodiment is merely one specific example of the invention described in the Summary of the Invention.

The above embodiment was used to describe the present invention. However, the present invention is not particularly limited to such an example, and may obviously be carried out using various embodiments without departing from the scope of the present invention.

The present invention may be used in a manufacturing industry of a continuously variable transmission.

What is claimed is:

1. A sealing structure for a continuously variable transmission that seals a clearance between a movable sheave and a cylinder of the continuously variable transmission including: two pulleys connected to an input shaft and an output shaft, respectively, with the pulleys each including the movable sheave and a fixed sheave that are disposed facing each other; a belt that bridges the pulleys; and the cylinder that forms a hydraulic pressure chamber on a rear side of the movable sheave, wherein the continuously variable transmission is capable of changing a groove width of each of the pulleys by moving the corresponding movable sheave though supply and discharge of a hydraulic pressure to and from the cylinder, the sealing structure comprising:
an outer peripheral side seal member that is ring-shaped and disposed in a ring-shaped groove formed in one of the movable sheave and the cylinder; and
an inner peripheral side seal member that is more elastic than the outer peripheral side seal member, ring-shaped, and disposed in a layered manner in the ring-shaped groove on an inner peripheral side with respect to the outer peripheral side seal member, wherein
a side of the outer peripheral side seal member where the outer peripheral side seal member contacts the inner peripheral side seal member is chamfered.

2. The sealing structure for a continuously variable transmission according to claim 1, wherein
the outer peripheral side seal member is chamfered by plane chamfering.

3. The sealing structure for a continuously variable transmission according to claim 1, wherein
the outer peripheral side seal member is a rectangular cross-sectioned seal ring, and
the inner peripheral side seal member is a circular cross-sectioned O-ring.

4. The sealing structure for a continuously variable transmission according to claim 1, wherein
the movable sheave is formed with a cylindrical portion that extends in an axial direction from an outer peripheral portion of the movable sheave,
the cylinder includes an outer peripheral portion that extends in a radial direction to near an inner peripheral surface of the cylindrical portion of the movable sheave, and
the seal member is attached to a groove formed along an entire circumference of an outer peripheral edge of the cylinder.
